(19) United States
(12) Patent Application Publication
(10) Pub. No.: US 2009/0271663 A1
(43) Pub. Date: Oct. 29, 2009

(54) PROVIDING DETAILED PROGRAM STATE INFORMATION FOR ERROR ANALYSIS

(76) Inventor: ROBERT G. VINING, Tucson, AZ (US)

Correspondence Address: INTERNATIONAL BUSINESS MACHINES CORPORATION, 9000 SOUTH RITA ROAD, TUCSON, AZ, 85744, US

(21) Appl. No.: 12/108,845

(22) Filed: Apr. 24, 2008

(51) Int. Cl. G06F 11/34

(52) U.S. Cl. 714/45; 714/E11.189

(57) ABSTRACT

A method of processing application execution errors in a data processing system includes recording function state changes of an application program during execution of the application program as a bitmap. The recorded bitmap is retrieved as a result of an application execution error. The application execution error may be identified using said bitmap.

### BACKGROUND OF THE INVENTION

1. Technical Field

The present invention relates in general to the field of error processing for a data processing system and, in particular, to tracking program function states for service analysis.

2. Description of the Related Art

Whenever a computer program experiences an error or abnormal termination, service personnel may be called upon to find the source of the error and may be asked to correct or repair the computer program code so that the error does not recur. Within even simple programs, there are a wide variety of possible error sources. This first level complexity is heightened by the varieties of user inputs, delays, variable values and other, often unpredictable, state combinations involved in ordinary program execution. In practice, correcting an issue may be an insignificant task compared to the difficulty of finding the source of the error.

Present programs often use a variety of methods to assist service personnel in finding the source of errors. Many programs provide service debugging information to service personnel in the form of execution logs written to disk as the program is executed. Return and reason codes may be generated and communicated to service personnel using some form of electronic message or using an application program interface. In some instances, a memory dump may be generated and written to a storage device, particularly in the event of an abnormal termination. The memory dump may be retrieved and communicated to the service personnel.

Error analysis data collection is generally balanced between completeness and intrusiveness. The process of generating and writing a log file consumes processor and disk resources. Thus, program performance is generally improved if less data is logged. Software vendors may also choose to limit the amount of logged data for competitive reasons. For example, a log may provide more information than is necessary for service personnel affiliated with a software vendor to resolve the problem at hand, providing functional footprints that may unintentionally reveal the inner workings of the execution of a program to competitors.

In many cases, standard return and reason codes may be too general to allow service personnel to pinpoint the cause of an error. The return and reason codes may direct service personnel to the location in the code where the error codes were set, but typically provide little indication of the execution path leading to the indicated code location.

Memory dumps are normally performed when there is an abnormal termination of the program or a catastrophic error that results in program failure. Decoding a memory dump to make a problem determination requires a programmer with sophisticated skills.

### SUMMARY OF THE INVENTION

Disclosed is a method of processing application execution errors. Function state changes are recorded as a bitmap during application execution. When an application execution error occurs, the bitmap is retrieved, and the application execution error is processed using the bitmap.

Further disclosed is a program product including a computer readable medium configured with program data for executing a process. Function state changes are registered during application execution, generating a bitmap using the function state changes. The bitmap is processed when the application execution results in an error condition.

Further disclosed is a data processing system including a processor, an interface module and data storage. The data storage is configured with program data for executing a process. Function state changes are registered during application execution, generating a bitmap using the function state changes. The bitmap is processed when the application execution results in an error condition.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram depicting a computing system in accordance with an embodiment; and

FIG. 2 is a flow chart depicting error data collection and processing in accordance with an embodiment.

### DETAILED DESCRIPTION OF AN ILLUSTRATIVE EMBODIMENT

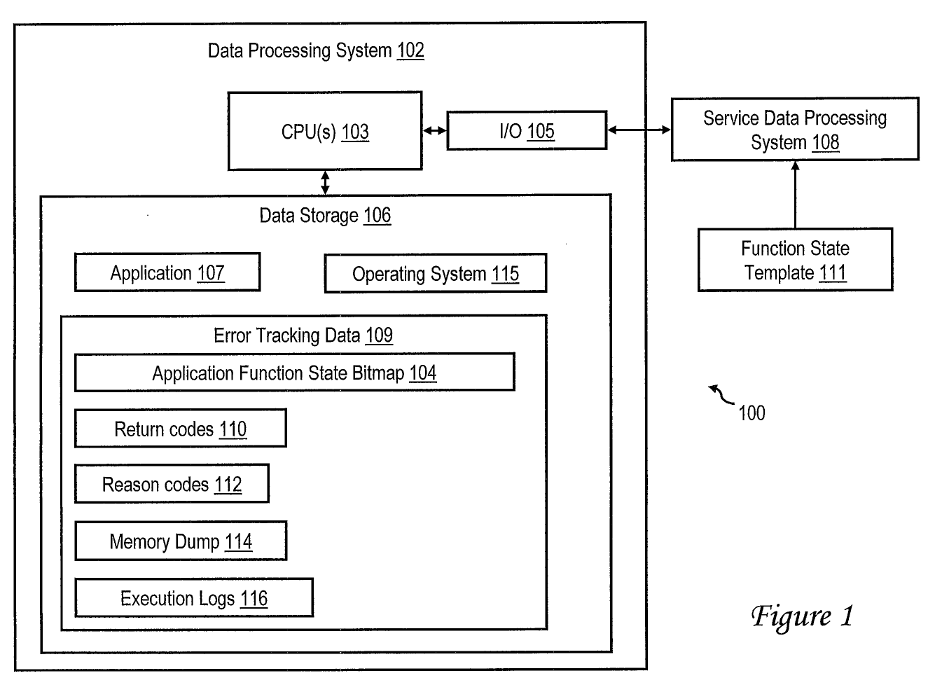

With reference to FIG. 1, a block diagram depicts an error analysis system 100 in accordance with an embodiment. Error analysis system 100 includes including a data processing system 102 that executes an application 107 and a service data processing system 108 coupled to data processing system 102. Data processing system 102 including one or more central processing units (CPUs) 103 for processing application 107, input/output (I/O) interface(s) 105 supporting external communication to service data processing system 108, and data storage 106 that stores an operating system 115, application 107 and data. While application 107 runs, data processing system 102 (e.g., operating system 115 and/or application 107) records in data storage 106 error tracking data 109 including, for example, function states of application 107 recorded as an application function state bitmap 104, reason codes 110, return codes 112, memory dump 114 and execution logs 116.

Application function state bitmap 104 may be used to record program state data for application 107 as it runs. Application function state bitmap 104 can be of any suitable length. As many current operating systems use 32-bit integers, one embodiment of application function state bitmap 104 may consist of a sequence of thirty-two bits. As application 107 runs, data processing system 102 (e.g., operating system 115 and/or application 107) may record state changes by updating bit values at specific bit positions in application function state bitmap 104 corresponding to observed program states. Below is an example of various function states in an exemplary application 107 and the bitmap value assigned to represent each state:

| State | Bitmap value |
|---|---|
| Initialization Completed | 00000000 00000000 00000000 00000001 |
| Input file opened | 00000000 00000000 00000000 00000010 |
| Output file opened | 00000000 00000000 00000000 00000100 |
| Read error | 00000000 00000000 00000000 00001000 |
| Write error | 00000000 00000000 00000000 00010000 |
| File closed | 00000000 00000000 00000000 00100000 |

In the above example, if the function represented by each state occurred, the resulting application function state bitmap 104 would be 00000000 00000000 00000000 00111111. The corresponding integer representation returned would be 63. If a read error occurred, the resulting application function state bitmap 104 would be 00000000 00000000 00000000 00110111, and the corresponding integer representation would be 55. To provide a comparable level of information using standard reason codes, a programmer would have to define a unique reason code for every possible combination of states.

When an error occurs in execution of application 107, data processing system 102 may communicate the contents of application function state bitmap 104 to a higher level caller, such as service data processing system 108. Prior to the communication of the contents of application function state bitmap 104, CPU 103 may optionally convert the contents of application function state bitmap 104 into an equivalent reason integer, typically by converting the application function state bitmap 104 from binary form into decimal, hexadecimal or any other appropriate numeric base. When paired with a standard return code, the reason integer may provide information corresponding to up to 4,294,967,295 possible state combinations that could have caused that return code. In the event of an error or otherwise, data processing system 102 may also provide service data processing system 108 with other error tracking data 109, including, for example, one or more of a reason code 112, a return code 110, a memory dump 114 and an execution logs 116.

Service data processing system 108 may use the contents of application function state bitmap 104 together with any other error tracking data 109 it receives for analysis, error determination and/or correction. Prior to analyzing the contents of application function state bitmap 104, service data processing system 108 may optionally regenerate a 32-bit string from the equivalent reason integer (if used).

To decode application function state bitmap 104, service data processing system 108 may use a function state template 111, which is typically generated and made available by the developers or distributers of application 107. Function state template 111 may correlate particular function states indicated by application function state bitmap 104 with possible errors. Service data processing system 108 may otherwise use the application function state bitmap 104 to identify the progression of function states within the application 107 at the time the return occurred. The indicated progression of function states aids in the problem determination process. As will be appreciated, service data processing system 108 may further analyze the various other error tracking data 109 to determine the cause of the error.

Service personnel have conventionally performed problem determination using memory dumps provided by customer installations. However, a customer may experience critical errors in the operation of a program that prevent a memory dump. If the error resulted in the return of an application function state bitmap 104 in conjunction with return and reason codes, service personnel could determine the program states that occurred in the operation of the program that caused the error. A complete analysis may be available without reference to the customer's memory dump 114, providing better First Failure Data Capture (FFDC) for program states that are currently not accurately represented by the standard return and reason codes. First Failure Data Capture may be implemented to provide an automated snapshot of the system environment when an unexpected internal error occurs.

The performance impact associated with this method may be negligible, as simple assignment statements may be all that are needed to reflect the state. The returning of a return and reason code are already implemented in a majority of programs today. The performance impact may be significantly less than the overhead incurred using a logging method and less intrusive than forcing a memory dump to obtain state data.

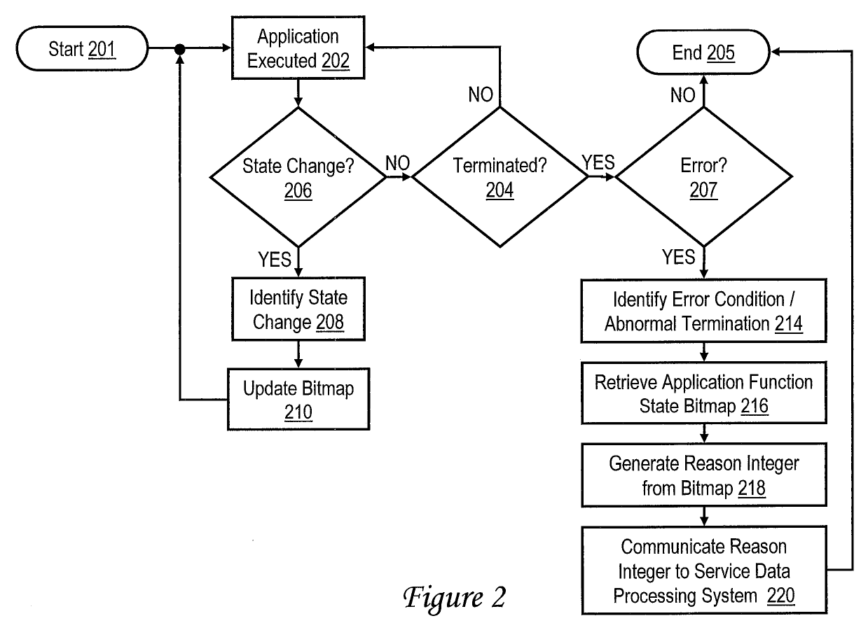

With reference to FIG. 2, a high level logical flowchart depicts a computer error collection and reporting process in accordance with an embodiment. Beginning at process block 201, an application 107 may be executed by a data processing system 102, as depicted at block 202. As application 107 is executed at block 202, CPU 103 detects whether any function state changes in application 107 have been made at decision block 206. If no function state changes are detected, the process proceeds to block 204, which is described below. If, however, a function state change is detected at block 206, the state change is identified by the CPU 103 at block 208, and the bit values of the stored application function state bitmap 104 are updated at block 210. With each function state change detected at decision block 206, the application function state bitmap 104 is updated, so that the stored application function state bitmap 104 reflects the state changes that have taken place up to that time during the program execution. From block 210, the process returns to block 202, which has been described.

Referring now to block 204, CPU 103 determines whether or not execution of application 107 has terminated. If not, the process returns to block 202, which has been described. If, however, execution of application 107 has terminated, CPU 103 detects the presence of any application execution errors or abnormal termination at decision block 207. If no errors occurred and the termination was not abnormal, the process terminates at block 205. However, if CPU 103 detects application processing errors or abnormal termination of application 107, the process proceeds to the error processing beginning at block 214 and following blocks.

Block 214 depicts identification of the error condition or abnormal termination. The application function state bitmap 104 is retrieved from data storage 106 at block 216 The application function state bitmap 104 may optionally be converted into a reason integer at block 218 as previously described. The reason integer may be communicated, along with any other error tracking data 109 that has been collected by data processing system 102, to the service data processing system 108 at block 220. As discussed above, service data processing system 108 may use the reason integer to reconstruct application function state bitmap 104 and to determine, optionally in conjunction with other error tracking data 109, to determine where the error arose. Following block 220, the process terminates at block 205.

As a final matter, it is important that while an illustrative embodiment of the present invention has been, and will continue to be, described in the context of a fully functional computer system with installed software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as floppy disks, hard disk drives, CD ROMs, and transmission type media such as digital and analogue communication links.

While the invention has been particularly shown and described with reference to a preferred embodiment, it will be understood by those skilled in the art that various changes in form and detail may be made therein without departing from the spirit and scope of the invention.

What is claimed is:

1. A method of processing application execution errors in a data processing system, said method comprising:
recording function state changes of an application program during execution of the application program as a bitmap;
retrieving said recorded bitmap in response to an application execution error; and
identifying said application execution error using said bitmap.

2. The method of claim 1, wherein said function state changes include a data access error.

3. The method of claim 1, wherein said step of identifying includes providing said recorded bitmap to a service data processing system.

4. The method of claim 1, wherein said application execution error is an abnormal termination.

5. The method of claim 1, wherein each bit of said bitmap represents a function state change.

6. The method of claim 1, wherein said error condition is a processing error.

7. A program product, comprising:
a computer readable storage medium; and
program code stored within the computer readable storage medium configured for performing a process including:
registering function state changes of an application program during execution of the application program;
generating a bitmap using said function state changes; and
outputting said bitmap when said application execution results in an error condition.

8. The program product of claim 7, wherein said function state changes include a data access error.

9. The program product of claim 7, wherein said outputting comprises providing said bitmap to a service data processing system.

10. The program product of claim 7, wherein said error condition is an abnormal termination.

11. The program product of claim 7, wherein each bit of said bitmap represents a function state change.

12. The program product of claim 7, wherein said error condition is a processing error.

13. A data processing system comprising:
a processor;
an interface coupled to said processor;
data storage coupled to said processor having program code stored therein configured for performing a process including:
registering function state changes of an application program during execution of the application program;
generating a bitmap using said function state changes; and
outputting said bitmap when said application execution results in an error condition.

14. The data processing system of claim 13, wherein said function state changes include a data access error.

15. The data processing system of claim 13, wherein said outputting comprises providing said bitmap to a service data processing system.

16. The data processing system of claim 13, wherein said error condition is an abnormal termination.

17. The data processing system of claim 13, wherein each bit of said bitmap represents a function state change.

18. The data processing system of claim 13, wherein said error condition is a processing error.
